(19) United States
(12) Patent Application Publication
(10) Pub. No.: US 2026/0131457 A1
(43) Pub. Date: May 14, 2026

(54) CONTROL METHOD FOR DRIVING STABILIZATION OF MOBILE ROBOT

(71) Applicant: SEOROBOTICS CO., LTD., Anyang-si, Gyeonggi-do (KR)

(72) Inventors: Jae Ik SHIM, Seoul (KR); Jong Hyun YOON, Seoul (KR); Young Jun LEE, Hwaseong-si, Gyeonggi-do (KR); Sung Wook JO, Suwon-si, Gyeonggi-do (KR)

(21) Appl. No.: 19/478,729

(22) PCT Filed: Nov. 21, 2024
(86) PCT No.: PCT/KR2024/018464

§ 371 Date: Oct. 24, 2025

(30) Foreign Application Priority Data
Jan. 9, 2024 (KR) 10-2024-0003807

(51) Int. Cl. B25J 9/16; B25J 5/00; B25J 13/08

(52) U.S. Cl. CPC B25J 9/162; B25J 5/007; B25J 9/1633; B25J 13/085

(57) ABSTRACT

A control method for stable operation of a mobile robot includes: providing a mobile robot, wherein the mobile robot includes: a first stabilizer, wherein a first flywheel rotates at high speed inside a first case, and a tilt of the first case is controlled about a pitch (Y) axis; a second stabilizer, wherein a second flywheel rotates at high speed inside a second case in an opposite direction to the first flywheel, and a tilt of the second case is controlled about a roll (X) axis; a base plate on which the first and second stabilizers are installed; a body frame on which the base plate is installed; and first to fourth weight sensors installed on the body frame to measure a weight of a mounted device, presetting coordinates of a Center of Mass (COM) of the mobile robot; calculating Zero Moment Point (ZMP) coordinates based on respective weight values measured by the first to fourth weight sensors; and generating a first torque from the first stabilizer or a second torque from the second stabilizer to bring the ZMP coordinates closer to the COM coordinates.

### TECHNICAL FIELD

The present invention relates to a control method for the stable travel of a mobile robot when the mobile robot is in motion because a mounted device, having its center of gravity at an arbitrary position, is mounted on the mobile robot.

### BACKGROUND ART

Generally, a mobile robot is equipped with a controller, a battery, motors, and wheels. Depending on its intended use, various mounted devices can be mounted, which can operate to perform special-purpose functions.

For example, a mobile robot can be a disinfection robot for sanitation tasks, a serving robot for delivering food, a security robot for patrol and surveillance, or a firefighting robot for fire suppression. In other words, a mobile robot can be used for various purposes.

A mounted device can include a chemical tank and pump for a disinfection robot, a box for holding food for a serving robot, a camera and lighting system for a security robot, or a firefighting apparatus including a fire extinguisher for a firefighting robot.

The mounted devices can have different centers of gravity, and in particular, the center of gravity can shift frequently when transporting items containing liquids, such as soups, beverages, or other fluids.

In other words, a problem may arise where the mobile robot's operation becomes unstable when it is in motion, leading to tilting or tipping over due to the center of gravity of the mounted device.

Furthermore, a surface on which the mobile robot moves may have various undefined obstacles; for instance, a path may be damaged with potholes, or objects may be placed in the way. Such objects may be removed on certain days, but on other days, new types of objects may be placed on the path.

When a mobile robot is in motion, if there is an obstacle on its path as described above, it may experience instability, such as jolting or tilting, while passing the obstacle.

### RELATED ART DOCUMENTS

### Patent Documents

(Patent Document 1) KR 10-2391562 B1
(Patent Document 2) KR 10-1740249 B1
(Patent Document 3) KR 10-2007-0072314 A
(Patent Document 4) KR 10-0685339 B1
(Patent Document 5) KR 10-2020-0053959 A

### DISCLOSURE

### Technical Problem

Therefore, the present invention has been made in view of the above problems, and it is one object of the present invention to provide a control method for the stable travel of a mobile robot, characterized by calculating a deviation in the center of gravity of a mounted device and compensating for the deviation using a stabilizer, thereby ensuring the stable motion of the robot.

### Technical Solution

In accordance with an aspect of the present invention, the above and other objects can be accomplished by the provision of a control method for stable operation of a mobile robot, the control method including: providing a mobile robot 10, wherein the mobile robot 10 includes: a first stabilizer 30, wherein a first flywheel 35 rotates at high speed inside a first case 34, and a tilt of the first case 34 is controlled about a pitch (Y) axis; a second stabilizer 40, wherein a second flywheel 45 rotates at high speed inside a second case 44 in an opposite direction to the first flywheel 35, and a tilt of the second case 44 is controlled about a roll (X) axis; a base plate 14 on which the first and second stabilizers 30 and 40 are installed; a body frame 12 on which the base plate 14 is installed; and first to fourth weight sensors 21 to 24 installed on the body frame 12 to measure a weight of a mounted device 100, presetting coordinates of a Center of Mass (COM) of the mobile robot 10; calculating Zero Moment Point (ZMP) coordinates pₓ, p_{y} based on respective weight values measured by the first to fourth weight sensors 21 to 24; and generating a first torque τ_{fr} from the first stabilizer 30 or a second torque τᵣᵣ from the second stabilizer 40 to bring the ZMP coordinates closer to the COM coordinates.

In addition, in the control method for the stable travel of a mobile robot according to an embodiment of the present invention, the ZMP coordinates pₓ, p_{y} may be calculated by equations below using force values F1 to F4 (Fᵢ) measured by the first to fourth weight sensors 21 to 24 (i), and a position rᵢₓ, r_{iy} of each of the first to fourth weight sensors 21 to 24 (i) with respect to the COM coordinates of the mobile robot 10:

$${p}_{x} = \frac{{\sum }_{i = 1}^{4} {r}_{ix} {F}_{i}}{{\sum }_{i = 1}^{4} {F}_{i}}$$

$${p}_{y} = \frac{{\sum }_{i = 1}^{4} {r}_{iy} {F}_{i}}{{\sum }_{i = 1}^{4} {F}_{i}}$$

In addition, in the control method for the stable travel of a mobile robot according to an embodiment of the present invention the first torque τ_{fr} and the second torque τᵣᵣ may be calculated by equations below:

$${p}_{x} = {p}_{cx} = \frac{{\sum }_{i = 1}^{4} {r}_{ix} {F}_{i} + {τ}_{rr}}{{\sum }_{i = 1}^{4} {F}_{i}} ⇒ {τ}_{rr} = {p}_{cx} {{{\sum }^{4}}_{i = 1}}_{} {F}_{i} - {{{\sum }^{4}}_{i = 1}}_{} {r}_{ix} {F}_{i}$$

$${p}_{y} = {p}_{cy} = \frac{{\sum }_{i = 1}^{4} {r}_{iy} {F}_{i} + {τ}_{fr}}{{\sum }_{i = 1}^{4} {F}_{i}} ⇒ {τ}_{fr} = {p}_{cy} {{{\sum }^{4}}_{i = 1}}_{} {F}_{i} - {{{\sum }^{4}}_{i = 1}}_{} {r}_{iy} {F}_{i}$$

Further, in the control method for the stable travel of a mobile robot according to an embodiment of the present invention, a plurality of first stabilizers 30 may be provided, and second stabilizers 40 may be provided in the same number as the first stabilizers 30.

Specific details of other embodiments are included in the detailed description and the accompanying drawings.

### Advantageous Effects

A control method for the stable travel of a mobile robot according to an embodiment of the present invention can stabilize the motion of a mobile robot by calculating changes in the center of gravity of a mounted device in real-time and actively compensating for such changes through the control of a stabilizer.

### DESCRIPTION OF DRAWINGS

FIG. 1 is a diagram illustrating a control method for the stable operation of a mobile robot according to an embodiment of the present invention.

FIG. 2 is an exemplary view illustrating a stabilizer of FIG. 1.

FIG. 3 is an exemplary sectional view illustrating the internal configuration of the stabilizer.

FIG. 4 is an exemplary view for explaining a moment of inertia.

FIGS. 5 and 6 are exemplary views for explaining the moment of inertia in the control method for the stable operation of a mobile robot according to an embodiment of the present invention.

FIG. 7 is an exemplary view for explaining the moment of inertia in a control method for the stable operation of a mobile robot according to another embodiment of the present invention.

### BEST MODE

The advantages and features of the present invention and the method of achieving them will become apparent with reference to the embodiments described in detail below together with the accompanying drawings.

[Description of Symbols]

| | | | |
|---|---|---|---|
| 10: | mobile robot | 12: | body frame |
| 14: | base plate | 16, 18: | wheel |
| 21, 22, 23, 24: | first to fourth weight | 30, 40: | first and second |
| | sensors | | stabilizers |
| 31, 41: | first and second | 32, 42: | first and second |
| | brackets | | tilting motors |
| 33, 43: | first and second shaft | 34, 44: | first and second cases |
| | brackets | | |
| 35, 45: | first and second | 100: | mounted device |
| | flywheels | | |

### MODE FOR CARRYING OUT THE INVENTION

Hereinafter, an embodiment of the present invention will be described in detail with reference to the accompanying drawings. The embodiment described below is provided as examples to help understand the present invention, and it should be understood that the present invention can be implemented in various ways different from the embodiment described herein. However, in the following description of the present invention, a detailed description of known functions and configurations incorporated herein will be omitted when it may make the subject matter of the present invention unclear. In addition, the accompanying drawings are not drawn to their actual scales and some components may be drawn with exaggerated sizes to help understand the invention.

Meanwhile, terms such as first, second, etc. may be used to describe various components, but the components should not be limited by the terms. The terms are used solely for the purpose of distinguishing one component from another. For example, without going beyond the scope of the present invention, the first component may be named the second component, and similarly, the second component may also be named the first component.

On the other hand, the terms described below are terms established in consideration of their functions in the present invention and thus may vary depending on the intention of a producer or custom. Accordingly, the definitions of the terms should be understood on the basis of the entire description of the present specification.

Throughout the specification, like reference numerals denote like elements.

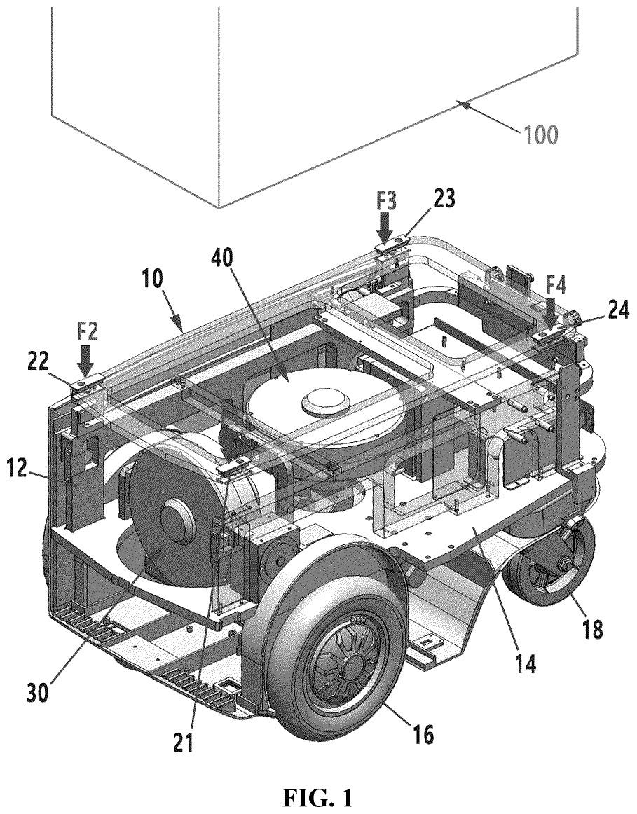

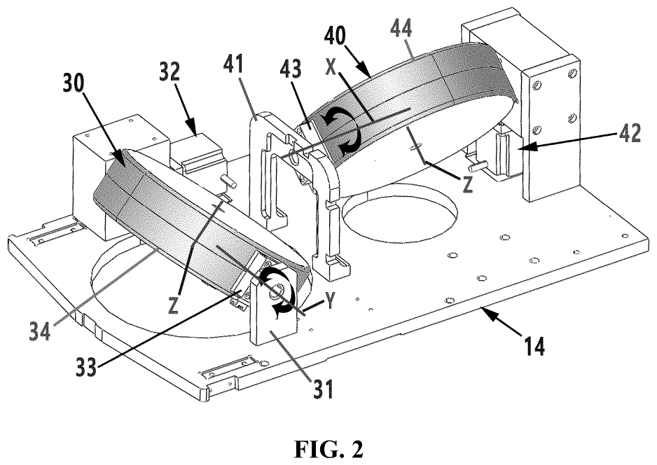

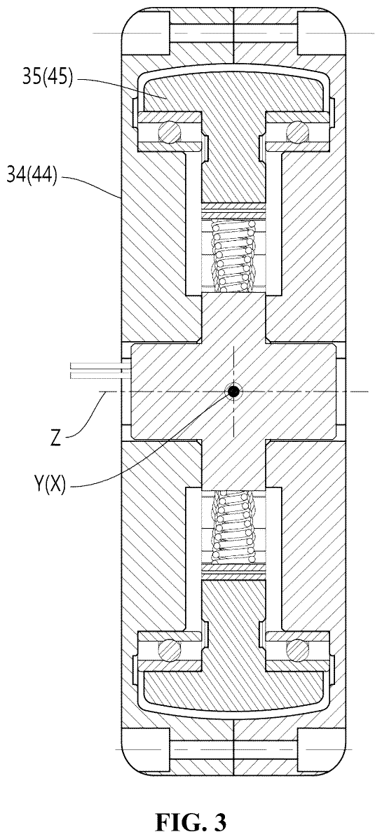

First, a hardware for stabilizing the travel of a mobile robot according to an embodiment of the present invention will be described with reference to FIGS. 1 to 3. FIG. 1 is a diagram illustrating the control method for the stable travel of a mobile robot according to an embodiment of the present invention. FIG. 2 is an exemplary view illustrating a stabilizer of FIG. 1. FIG. 3 is an exemplary sectional view illustrating the internal configuration of the stabilizer.

A mobile robot 10 may be configured to include a body frame 12, which constitutes the framework of the mobile robot 10, and wheels 16 and 18 for motion.

A base plate 14 may be fixed to the body frame 12, and a mounted device 100 may be fixed on the upper part of the body frame 12.

The mounted device 100 may be a disinfection device, a serving device, a security device, or a firefighting device, depending on the intended use of the mobile robot 10.

The mounted device 100 is placed on the mobile robot 10 and may be secured by mounting portions at three or four locations. An embodiment of the present invention describes an example where mounting portions are provided at four locations.

First to fourth weight sensors 21 to 24 may be provided at the mounting portion at the upper part of the body frame 12, and the first to fourth weight sensors 21 to 24 may measure the weight exerted by the mounted device 100.

Each mounted device 100 may have a different center of gravity position, and particularly when an item containing liquid is mounted, the center of gravity may change in real-time depending on the traveling speed of the mobile robot 10 and the surface condition of its path. Furthermore, the center of gravity of the mobile robot 10 may change frequently depending on the direction of its motion and turning. In addition, the center of gravity may change when the mobile robot 10 is stationary versus when it is in motion.

In other words, a change in the center of gravity is a factor that destabilizes the posture of the mobile robot 10. For example, the mobile robot 10 may tilt or shake, and in such a case, the weight values detected by the first to fourth weight sensors 21 to 24 may differ from one another.

Meanwhile, a stabilizer may be configured inside the body frame 12.

Regarding the configuration of the stabilizer, first and second stabilizers 30 and 40 may be arranged on the base plate 14, as shown in FIG. 2.

A first bracket 31 and a first tilting motor 32 are installed on the base plate 14, and a first case 34 is rotatably installed on the first bracket 31 and the first tilting motor 32.

To explain in more detail, the first case 34 may be provided in the shape of a disk, a first shaft bracket 33 is installed on one side of the first case 34, and the first shaft bracket 33 is installed on the first bracket 31 by a mechanical element such as a bearing.

The first tilting motor 32 may adjust a tilt angle of the first case 34 according to a first control value of the controller.

Inside the first case 34, a first flywheel 35 is installed to be rotatable about a yaw (Z) axis, and the first flywheel 35 may be rotated at high speed by an inner motor.

A second stabilizer 40 has the same overall configuration as the first stabilizer 30, but the direction in which the yaw (Z) axis of its flywheel tilts is different from that of the first stabilizer 30.

To explain in more detail, the first flywheel 35 of the first stabilizer 30 is arranged such that the first case 34 is tilted about a pitch (Y) axis, and a second flywheel 45 rotates at high speed in the opposite direction to the first flywheel 35, with a second case 44 being arranged to be tilted about a roll (X) axis.

A second bracket 41 and a second tilting motor 42 are installed on the base plate 14, and the second case 44 is rotatably installed on the second bracket 41 and the second tilting motor 42. The second case 44 may be provided in the shape of a disk, a second shaft bracket 43 is installed on one side of the second case 44, and the second shaft bracket 43 is installed on the second bracket 41 by a mechanical element such as a bearing.

The second tilting motor 42 may adjust the tilt angle of the second case 44 according to a second control value from the controller.

Inside the second case 44, the second flywheel 45 is installed to be rotatable about the yaw (Z) axis, and the second flywheel 45 may be rotated at high speed by an inner motor.

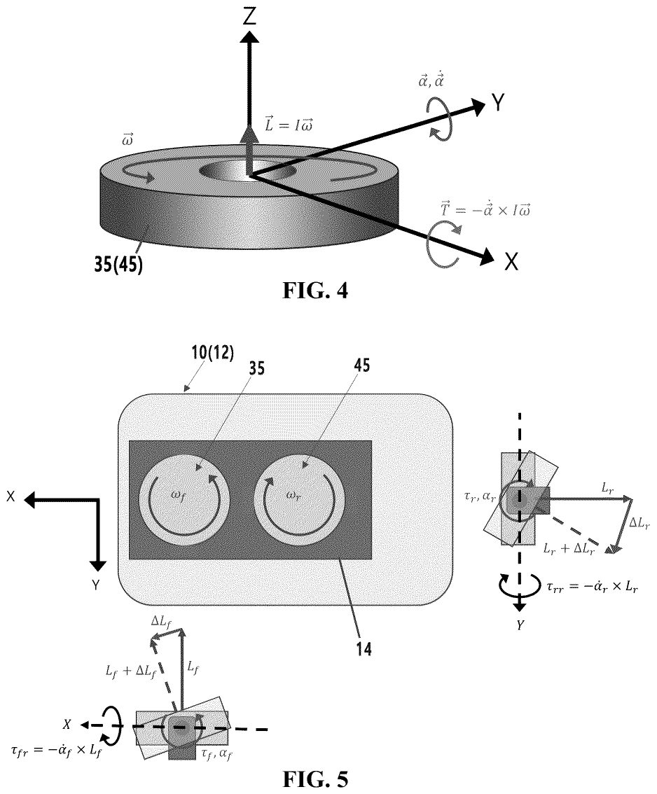

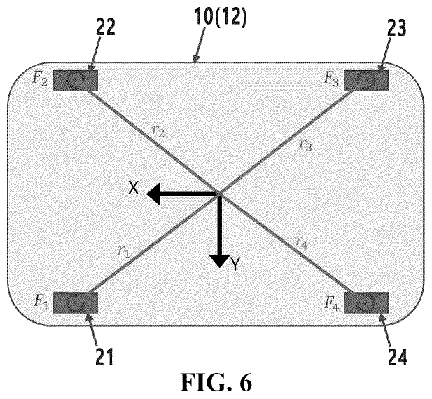

Hereinafter, the control method for the stable operation of a mobile robot according to an embodiment of the present invention will be described with reference to FIGS. 4 to 6. FIG. 4 is an exemplary view for explaining the moment of inertia. FIGS. 5 and 6 are exemplary views for explaining the moment of inertia in the control method for the stable operation of a mobile robot according to an embodiment of the present invention.

When the first and second flywheels 35 and 45 rotate at high speed about the yaw (Z) axis, rotational inertia is generated.

Rotational inertia is the force that seeks to maintain the initial posture of the yaw (Z) axis when the first and second flywheels 35 and 45 rotate at high speed.

In other words, if the first case 34 tilts while the first flywheel 35 is rotating at high speed, a reaction force is generated in the direction opposite to the tilt, which attempts to return the first case 34 to its posture before tilting.

Similarly to the first flywheel 35, the second flywheel 45 generates rotational inertia during high-speed rotation. Due to this rotational inertia, a reaction force is generated that attempts to return it to its posture before tilting when the second case 44 is tilted.

The moment of inertia will be described with reference to FIG. 4. When a disk with a moment of inertia I rotates at a constant velocity ω, the angular momentum L may be calculated as the product of the moment of inertia and the constant velocity, which is L=Iω. Here, the disk may be understood as the first and second flywheels 35 and 45.

When the rotating disk is rotated by an angle α at a velocity \dot{α} about the Y-axis, a torque is generated. The change in angular momentum over time is equal to the torque acting on the object.

The torque acting on the rotating disk may be calculated by Equation 1.

$${\vec{τ}}_{disk} = \frac{d}{dt} [ \begin{matrix}0 \\ 0 \\ I ω\end{matrix} ] = [ \begin{matrix}0 \\ 0 \\ I \dot{ω}\end{matrix} ] + [ \begin{matrix}0 \\ \dot{α} \\ 0\end{matrix} ] \times [ \begin{matrix}0 \\ 0 \\ I ω\end{matrix} ] = [ \begin{matrix}I \dot{α} ω \\ 0 \\ 0\end{matrix} ] \qquad [ Equation 1 ]$$

Here, \vec{τ}disk is a torque, I is a moment of inertia, and @ is a rotational constant velocity.

In an embodiment of the present invention, the repulsive torque T in the X-axis direction of the first bracket 31 or the second bracket 41 may be calculated as the product of the moment of inertia I, the rotational displacement α, and the rotational velocity α, which is T=−I\dot{α}ω.

As shown in FIG. 2, an embodiment of the present invention includes the first stabilizer 30 and the second stabilizer 40, wherein the first stabilizer 30 has the first flywheel 35, and the second stabilizer 40 has the second flywheel 45.

FIG. 5 is an exemplary view for explaining an operating principle in the control method for the stable operation of a mobile robot according to an embodiment of the present invention, which simplifies components and shows a repulsive torque generated by flywheels.

The description of each symbol in the mathematical formula shown in FIG. 5 is as follows.
L_{f}: Angular momentum of the first stabilizer 30 rotating at a constant velocity ω_{f}
ΔL_{f}: Change in the angular momentum of the first stabilizer 30
α_{f}, \dot{α}_{f}: Angle and angular velocity of the first flywheel 35 of the first stabilizer 30 rotated about the pitch (Y) axis
τ_{fr}: First torque generated by the first stabilizer 30
Lᵣ: Angular momentum of the second stabilizer 40 rotating at a constant velocity ωᵣ
ΔLᵣ: Change in the angular momentum of the second stabilizer 40
αᵣ, \dot{α}ᵣ: Angle and angular velocity of the second flywheel 45 of the second stabilizer 40 rotated about the roll (X) axis
τᵣᵣ: Second torque generated by the second stabilizer 40

The first flywheel 35 of the first stabilizer 30 and the second flywheel 45 of the second stabilizer 40 rotate in opposite directions, and thereby, the rotational forces in the yaw (Z) axis direction may be canceled out.

By rotating the first flywheel 35 of the first stabilizer 30 about the pitch (Y) axis, a first torque τ_{fr}=−\dot{α}_{f} L_{f} that tilts about the roll (X) axis is generated, and rotation in the roll direction may thereby be canceled out.

By rotating the second flywheel 45 of the second stabilizer 40 about the roll (X) axis, a second torque τᵣᵣ=−\dot{α}ᵣ Lᵣ about the pitch (Y) axis is generated, and rotation in the pitch direction may thereby be canceled out.

In the control method for the stable operation of a mobile robot according to an embodiment of the present invention, the operation of the first and second stabilizers may be determined using Zero Moment Point (ZMP) coordinates. This will be described with reference to FIG. 6 and Equations 2 and 3.

Based on Computer-Aided Design (CAD) data, the Center of Mass (COM) coordinates p_{cx}, p_{cy} of the mobile robot 10 may be obtained.

$${p}_{x} = \frac{{\sum }_{i = 1}^{4} {r}_{ix} {F}_{i}}{{\sum }_{i = 1}^{4} {F}_{i}} \qquad [ Equation 2 ]$$

$${p}_{y} = \frac{{\sum }_{i = 1}^{4} {r}_{iy} {F}_{i}}{{\sum }_{i = 1}^{4} {F}_{i}}$$

The ZMP coordinates pₓ, p_{y} are calculated using the force values F1 to F4 (Fᵢ) from each of weight sensors 21 to 24 (i), and the position rᵢₓ, r_{iy} of each weight sensor relative to a local coordinate system in which the Center of Mass (COM) of the mobile robot 10 is the origin. Here, the ZMP coordinates may also be calculated based on the same coordinate system as the COM.

$${p}_{x} = {p}_{cx} = \frac{{\sum }_{i = 1}^{4} {r}_{ix} {F}_{i} + {τ}_{rr}}{{\sum }_{i = 1}^{4} {F}_{i}} ⇒ {τ}_{rr} = {p}_{cx} {{{\sum }^{4}}_{i = 1}}_{} {F}_{i} - {{{\sum }^{4}}_{i = 1}}_{} {r}_{ix} {F}_{i} \qquad [ Equation 3 ]$$

$${p}_{y} = {p}_{cy} = \frac{{\sum }_{i = 1}^{4} {r}_{iy} {F}_{i} + {τ}_{fr}}{{\sum }_{i = 1}^{4} {F}_{i}} ⇒ {τ}_{fr} = {p}_{cy} {{{\sum }^{4}}_{i = 1}}_{} {F}_{i} - {{{\sum }^{4}}_{i = 1}}_{} {r}_{iy} {F}_{i}$$

If the absolute value of pₓ is greater than ‘0’ or the absolute value of p_{y} is greater than ‘0’, it may be understood that the ZMP is moving away from the COM.
τ_{fr} is the first torque generated by the first stabilizer 30.
τᵣᵣ is the second torque generated by the second stabilizer 40.

When the ZMP coordinates move away from the COM coordinates, the first and second stabilizers 30 and 40 generate torque to move the ZMP coordinates toward the COM coordinates.

As described above, the control method for the stable operation of a mobile robot according to an embodiment of the present invention calculates the ZMP coordinates based on the weight values acting on the first to fourth weight sensors 21 to 24 from the mounted device 100, and generates torque from the first and second stabilizers 30 and 40 to bring the ZMP coordinates closer to the COM coordinates of the mobile robot 10, and thereby, it may control the ZMP coordinates to match or approach the COM coordinates.

In other words, the control method for the stable operation of a mobile robot according to an embodiment of the present invention can stabilize the robot's motion by calculating the ZMP coordinates in real-time when the mobile robot 10 is in motion, and controlling the ZMP coordinates to match or approach the COM coordinates, thereby resolving any tilting or instability of the mobile robot 10.

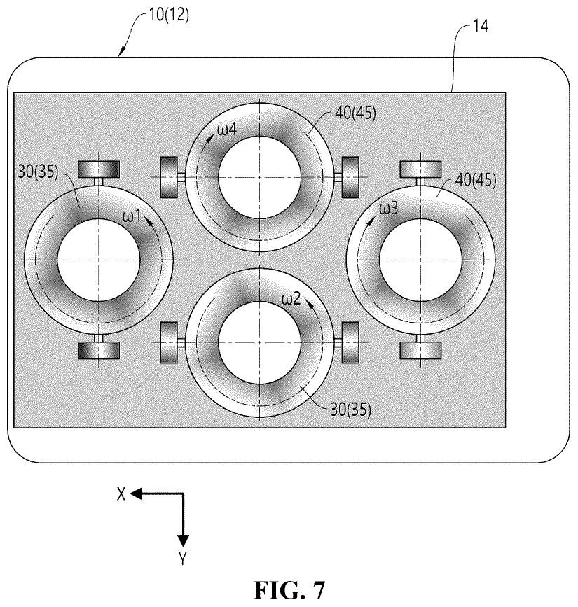

Meanwhile, in the mobile robot 10 according to an embodiment of the present invention, a plurality of the first stabilizers 30 may be provided, and the second stabilizers 40 may be provided in the same number as the first stabilizers 30, as shown in FIG. 7.

The first flywheel 35 and the second flywheel 45 may move at the same rotational speed in opposite directions.

FIG. 7 illustrates an example in which a plurality of first stabilizers 30, each including a first flywheel 35, are provided, and the second stabilizers 40 are provided in the same number as the first stabilizers 30.

In the control method for the stable operation of a mobile robot according to an embodiment of the present invention, the mobile robot 10 may counteract tilting about the roll (X) axis and the pitch (Y) axis; however, because the number of stabilizers corresponding to each rotation is singular (one), a rotation about the yaw (Z) axis may be generated while the device is in operation.

For example, in FIG. 5, when the first stabilizer 30 operates and the initial angular momentum L_{f} increases by ΔL_{f} about the roll (X) axis, the angular momentum about the yaw (Z) axis decreases by ΔL_{f}, thus causing a rotation about the yaw (Z) axis that may become a minute unstable factor in the operation of the mobile robot 10.

To respond to the rotation about the yaw (Z) axis, if a pair of stabilizers with flywheels rotating in opposite directions is made to correspond to rotation in one direction, the mobile robot 10 may be controlled stably without generating rotation about the yaw (Z) axis.

As shown in FIG. 7, if four stabilizers are arranged, the flywheels of the third and fourth stabilizers, which correspond to rotation about the roll (X) axis, rotate in opposite directions, thereby generating a force that attempts to rotate the body frame 12 in the opposite direction; and while changing the angular momentum of the roll (X) axis, the change in the angular momentum of the yaw (Z) axis may be canceled out.

Thereby, the mobile robot 10 may more reliably stabilize its traveling posture by suppressing the rotational motion about the yaw (Z) axis which may be minutely generated when any one of the flywheels stabilizes the posture through rotational inertia during high-speed rotation.

While embodiments of the present invention have been described with reference to the accompanying drawings, a person skilled in the art to which the present invention pertains will understand that the present invention can be embodied in other specific forms without departing from its technical spirit or essential features.

Therefore, it should be understood that the embodiments described above are illustrative in all respects and not limiting. The scope of the present invention is defined by the appended claims, and all modifications or variations derived from the meaning and scope of the claims and their equivalents should be interpreted as being included within the scope of the present invention.

### INDUSTRIAL APPLICABILITY

A control method according to an embodiment of the present invention can be used for stabilizing the travel of a mobile robot.

1. A control method for stable operation of a mobile robot, the control method comprising:
providing a mobile robot, wherein the mobile robot comprises: a first stabilizer, wherein a first flywheel rotates at high speed inside a first case, and a tilt of the first case is controlled about a pitch axis; a second stabilizer, wherein a second flywheel rotates at high speed inside a second case in an opposite direction to the first flywheel, and a tilt of the second case is controlled about a roll axis; a base plate on which the first and second stabilizers are installed; a body frame on which the base plate is installed; and first to fourth weight sensors installed on the body frame to measure a weight of a mounted device,
presetting coordinates of a Center of Mass (COM) of the mobile robot;
calculating Zero Moment Point (ZMP) coordinates pₓ, p_{y} based on respective weight values measured by the first to fourth weight sensors (i); and
generating a first torque τ_{fr} from the first stabilizer or a second torque τᵣᵣ from the second stabilizer to bring the ZMP coordinates closer to the COM coordinates.

2. The control method according to claim 1, wherein the ZMP coordinates pₓ, p_{y} are calculated by equations below using force values (Fᵢ) measured by the first to fourth weight sensors (i), and a position rᵢₓ, r_{iy} of each of the first to fourth weight sensors (i) with respect to the COM coordinates of the mobile robot:
$${p}_{x} = \frac{{\sum }_{i = 1}^{4} {r}_{ix} {F}_{i}}{{\sum }_{i = 1}^{4} {F}_{i}}$$
$${p}_{y} = \frac{{\sum }_{i = 1}^{4} {r}_{iy} {F}_{i}}{{\sum }_{i = 1}^{4} {F}_{i}} .$$

3. The control method according to claim 2, wherein the first torque τ_{fr} and the second torque τᵣᵣ are calculated by equations below:
$${p}_{x} = {p}_{cx} = \frac{{\sum }_{i = 1}^{4} {r}_{ix} {F}_{i} + {τ}_{rr}}{{\sum }_{i = 1}^{4} {F}_{i}} ⇒ {τ}_{rr} = {p}_{cx} {{{\sum }^{4}}_{i = 1}}_{} {F}_{i} - {{{\sum }^{4}}_{i = 1}}_{} {r}_{ix} {F}_{i}$$
$${p}_{y} = {p}_{cy} = \frac{{\sum }_{i = 1}^{4} {r}_{iy} {F}_{i} + {τ}_{fr}}{{\sum }_{i = 1}^{4} {F}_{i}} ⇒ {τ}_{fr} = {p}_{cy} {{{\sum }^{4}}_{i = 1}}_{} {F}_{i} - {{{\sum }^{4}}_{i = 1}}_{} {r}_{iy} {F}_{i} .$$

4. The control method according to claim 1, wherein a plurality of first stabilizers are provided, and second stabilizers are provided in the same number as the first stabilizers.
